(19) United States
(12) Patent Application Publication
(10) Pub. No.: US 2008/0054788 A1
(43) Pub. Date: Mar. 6, 2008

(54) DISPLAY PANEL WITH ELECTRODE WIRES

(76) Inventors: Nobuhiro Iwase, Miyazaki (JP); Yasuhiko Kunii, Miyazaki (JP); Koji Ohira, Miyazaki (JP); Yoshikazu Kanazawa, Kawasaki (JP); Taizo Ohno, Inagi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/850,096

(22) Filed: Sep. 5, 2007

(30) Foreign Application Priority Data
Sep. 6, 2006 (JP) 2006-241378

(51) Int. Cl. H01J 1/62

(52) U.S. Cl. 313/483

(57) ABSTRACT

In a display panel having electrode wires connected to drive units, the electrode wires form N number of electrode wire groups, each of which is composed of M number of successive adjacent electrode wires, and the display panel has first and second connecting terminal groups, arranged along first and second sides of the panel respectively and each having M terminals. K number of electrode wire groups out of the N number of electrode wire groups (K<N) are connected via leading lines to the first connecting terminal groups respectively, N−K number of electrode wire groups out of the N number of electrode wire groups are connected via the leading lines to the second connecting terminal groups respectively, and the K number of electrode wire groups and the N−K number of electrode wire groups are arranged alternately or in alternate sets of a plurality of groups.

### CROSS-REFERENCE TO RELATED APPLICATION

This application is based upon and claims the benefit of priority from the prior Japanese Patent Application No. 2006-241378, filed on Sep. 6, 2006, the entire contents of which are incorporated herein by reference.

### BACKGROUND OF THE INVENTION

1. Field of the Invention

The present invention relates to a display panel having electrode wires at a display area, and more particularly to a display panel having the optimized connection structure between drive units and the electrode wires.

2. Description of the Related Art

A display area of a flat display panel, such as a plasma display panel (PDP), a liquid crystal display panel and an organic EL panel, has a plurality of electrode wires extending in a horizontal direction and a plurality of electrode wires extending in a vertical direction. These electrode wires are connected via a group of connecting terminals of a panel edge to drive units having drive circuit devices and circuit boards connected thereto. For example, in the case of a PDP, a flexible printed circuit board (FPC) is connected at a panel edge to a group of connecting terminals that is led from the electrode wires. In other display panel as well, electrode wires are connected to the drive units.

Due to the demands of cost reduction, it is desired that the flexible printed circuit board configuring the drive unit have a predetermined width with a higher density of the conductive wires. It is because the cost of the board itself can be reduced by providing high wiring density and a narrow width. However, in order to keep the reliability of a connection with the group of connecting terminals (a short among the terminals, etc.) high, there is a certain limit to the density of the conductive wires.

On the other hand, the pitches and density of the electrode wires formed in the display area are determined by the panel size and the display panel specs. For example, in the case in which the PDP is of a full-spec hi-vision television (high-definition television: HDTV), 1920×1080 pixels are required and a horizontal resolution of 5760 cells=1920 pixels×3 colors is required. That is, the number of address electrodes extending in the vertical direction is 5760. Considering that the panel size is fixed, the higher the resolution, the narrower the spaces (pitches) between the address electrodes.

Therefore, in order to absorb the difference between the pitch of the electrode wires, which is determined by the circumstances of the display panel, and the size of the connection board, which is determined by the circumstances of the drive unit, connecting terminal groups that are led from the electrode wires are provided at an edge of the display panel. If the pitch of the electrode wires is larger than the pitch of the conductive wires on the drive unit side, the leading lines are formed into a shape such that the width thereof tapers down from the electrode wires toward the connecting terminal groups. In this case, the connecting terminal groups can be arranged on one side of the display panel. Such arrangement is described in, for example, Japanese Unexamined Patent Publication No. 2001-283736 and No. 2004-6396.

If, on the other hand, the number of electrode wires increases as the resolution increases, and the pitch of the electrode wires is narrower than the pitch of the conductive wires on the drive unit side, the connecting terminal groups cannot be arranged on one side of the display panel, and thus have to be arranged on two sides, i.e., the top and bottom, of the display panel. For example, in case of the address electrodes of the PDP, the connecting terminal groups are provided at upper and lower ends of the display panel and the flexible printed circuit board of the drive unit is connected to the connecting terminals from upper and lower. Such a configuration is described in, for example, Japanese Unexamined Patent Publication No. 2005-340131.

### SUMMARY OF THE INVENTION

According to the configuration described in the above Patent Literature 3, although not exactly specified therein, the equal number of drive units are connected to the top and bottom of the display panel, and electrode wires are alternately connected to a top and bottom pair of drive units. With this connection, the difference between the width of a connecting terminal group connected to one drive unit and the width of a electrode wire group increases, and the density of the leading lines also increases, causing disconnection.

Moreover, a standard drive circuit device that is currently available on the market drives 384 (=128×3) electrodes, while, according to the standards of a full-spec hi-vision display panel, 1920 pixels×3 colors=5760 pixels need to be formed in the horizontal direction. In this case, according to the above Patent Literature 3, since the top and bottom of the display panel are provided with the equal number of (a total of sixteen, eight each on top and bottom) drive units, 384×16>5760 is set, thus some output terminals of the drive circuit device are unused and wasted.

An object of the present invention, therefore, is to provide a display panel having the optimized connection structure between the electrode wires and the drive units of the display panel.

In order to achieve the above object, according to a first aspect of the present invention, there is provided a display panel having a plurality of electrode wires that are formed in a display area and connected to a plurality of drive units,

wherein the plurality of electrode wires form N number of electrode wire groups, each of which is composed of M number of successive adjacent electrode wires,

the display panel has:

a plurality of first connecting terminal groups, which are arranged along a first side of the display panel and each of which has M terminals; and

a plurality of second connecting terminal groups, which are arranged along a second side of the display panel opposite to the first side and each of which has M terminals,

K number of electrode wire groups out of the N number of electrode wire groups (K<N) are connected via leading lines to the first connecting terminal groups respectively,

N−K number of electrode wire groups out of the N number of electrode wire groups are connected via leading lines to the second connecting terminal groups respectively, and

the K number of electrode wire groups and the N−K number of electrode wire groups are arranged alternately or in alternate sets of a plurality of groups.

According to a preferred embodiment of the above first aspect, the number of M electrode wires is 384, the number of M terminals is 384, the number of N groups is 15, and the electrode wires are composed of 5760 electrodes.

According to a preferred embodiment of the above first aspect, the number of K groups is seven, the number of N−K groups is eight, seven groups of the first connecting terminal groups are connected to seven drive units respectively along the first side, and eight groups of the second connecting terminal groups are connected to eight drive units respectively along the second side.

In order to achieve the above object, according to a second aspect of the present invention, there is provided a display panel module having: a display panel in which a plurality of electrode wires are formed in a display area thereof; and a plurality of drive units to which the electrode wires are connected respectively,

wherein the plurality of electrode wires form N number of electrode wires, each of which is composed of M number of successive adjacent electrode wires,

the display panel has:

a plurality of first connecting terminal groups, which are arranged along a first side of the display panel and each of which has M terminals; and

a plurality of second connecting terminal groups, which are arranged along a second side of the display panel opposite to the first side and each of which has M terminals,

K number of electrode wire groups out of the N number of electrode wire groups (K<N) are connected via leading lines to the first connecting terminal groups respectively,

N−K number of electrode wire groups out of the N number of electrode wire groups are connected via leading lines to the second connecting terminal groups respectively,

the K number of electrode wire groups and the N−K number of electrode wire groups are arranged alternately or in alternate sets of a plurality of groups, and

the plurality of drive units are connected to the first and second connecting terminal groups respectively.

According to the above aspects of the present invention, the electrode wire groups that are constituted by predetermined number of successive adjacent electrode wires are connected to the connecting wire groups at the top and bottom respectively in units of the electrode wire groups. Therefore, the pattern density of the leading lines between the electrode wire groups and connecting wire groups can be reduced. Moreover, the drive circuit devices that are connected to the connecting wire groups can be used economically.

### BRIEF DESCRIPTION OF THE DRAWINGS

FIG. 1 is a development view of a configuration of a display panel according to the present embodiment.

FIG. 2 is a figure showing a relationship between address electrodes and connecting terminals of a conventional rear glass substrate.

FIG. 3 is a figure showing a relationship between address electrodes and connecting terminals of another conventional rear glass substrate.

FIG. 4 is a configuration diagram of the display panel according to the present embodiment.

FIG. 5 is a configuration diagram of a display panel module according to the present embodiment.

FIG. 6 is a configuration diagram of another display panel according to the present embodiment.

FIG. 7 is a configuration diagram of yet another display panel according to the present embodiment.

### DESCRIPTION OF THE PREFERRED EMBODIMENTS

Hereinafter, an embodiment of the present invention is described with reference to the drawings. However, the technical field of the present invention is not limited to this embodiment, and thus covers the matters described in the patent claims and equivalents thereof.

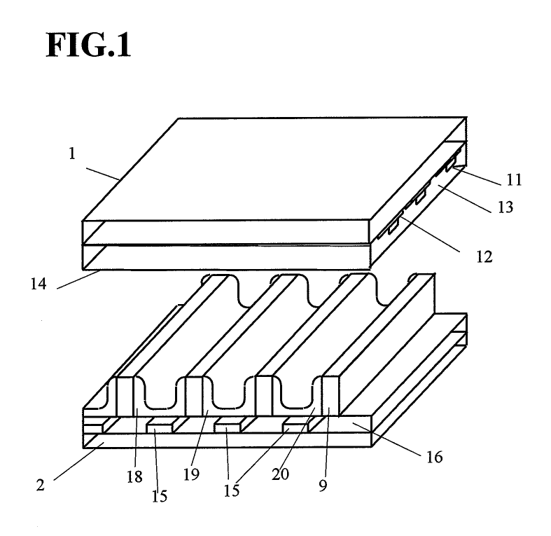

FIG. 1 is a development view of a configuration of a display panel according to the present embodiment. The display panel shown in FIG. 1 is an example of a three-electrode plane discharge type plasma display panel. In this display panel, a front glass substrate (panel) 1 and a rear glass substrate (panel) 2 are disposed with a discharge space therebetween. A plurality of display electrodes (electrode wires) extending in the horizontal direction are formed on the front glass substrate 1, and each of the display electrodes is constituted by an ITO transparent electrode 12 and a bus electrode 11 formed thereon. These display electrodes 11, 12 are covered by a dielectric layer 13, and this dielectric layer is covered by a protective layer 14.

On the other hand, a plurality of address electrodes (electrode wires) 15 extending in the vertical direction are formed on the rear glass substrate 2, and these address electrodes 15 are covered by a dielectric layer 16. Stripe-like partition walls 9 are formed between the address electrodes 15, and RGB fluorescent materials 18, 19 and 20 are formed on the dielectric layer 16 and address electrodes 15. The intersections of the display electrodes and the address electrodes form discharge cells, and one pixel is composed of three discharge cells of RGB.

According to the specification of a full-spechi-vision television, the number of display pixels is 1920×1080. Therefore, it is necessary to provide 1080 discharge areas between the display electrodes, as well as 1920×3=5760 address electrodes and 5760×1080 discharge units.

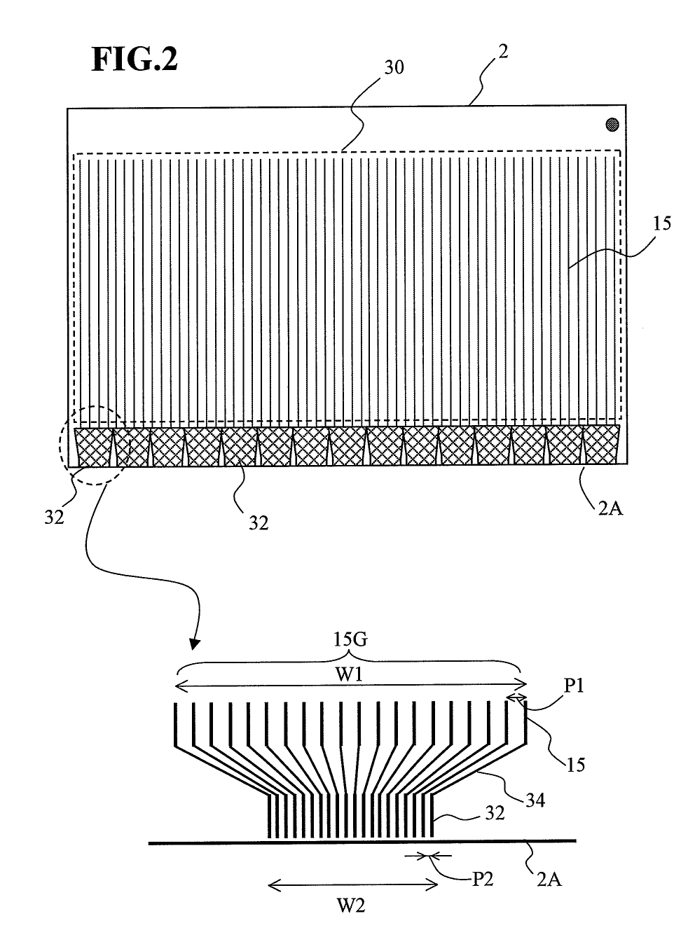

FIG. 2 is a figure showing a relationship between the address electrodes and the connecting terminals of a conventional rear glass substrate. The figure shows a partially enlarged view of a connecting terminal group 32. First, a plurality of address electrodes 15 are formed in an effective display area 30 surrounded by a dashed line shown in the rear glass substrate 2. An address electrode group 15G with a predetermined number of address electrodes is connected via leading lines 34 to the connecting terminal group 32 outside the effective display area. FIG. 2 shows fifteen address electrode groups 15G and connecting terminal groups 32. Also, a plurality of connecting terminal groups 32 are arranged along one side 2A of the glass substrate 2.

In this example, a pitch (distance) of the address electrodes 15, P1, is wider than a pitch of the connecting terminal groups 32, P2. As described above, the pitch of the address electrodes P1 is determined by the size of the panel and the number of electrodes, while the pitch of the connecting terminals P2 depends on the pitch of the conductors of the flexible printed circuit board of each drive unit. As a result, the horizontal width W1 of an address electrode group 15G is wider than the horizontal width W2 of a connecting terminal group, thus all connecting terminal groups 32 can be disposed along the side 2A of the panel 2.

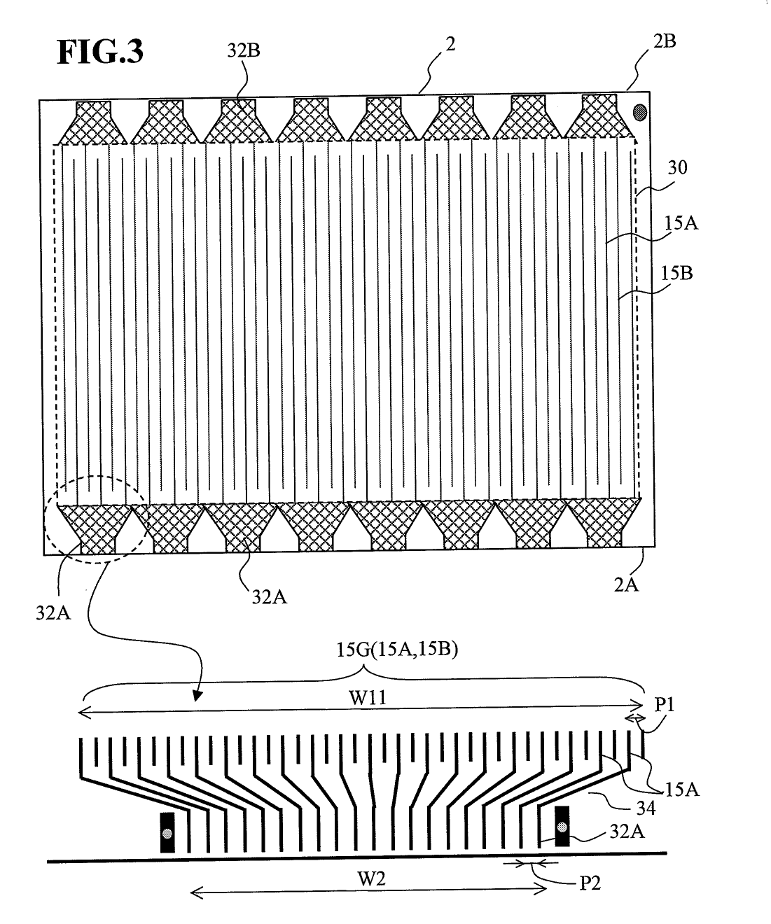

FIG. 3 is a figure showing a relationship between the address electrodes and the connecting terminals of another conventional rear glass substrate. As with FIG. 2, the plurality of address electrodes 15A and 15B are formed in the effective display area 30 surrounded by a dashed line shown in the rear glass substrate 2, and the address electrode group 15G with a predetermined number of address electrodes is connected via the leading lines 34 to the connecting terminal groups 32A and 32B. Unlike the example shown in FIG. 2, the connecting terminal groups 32A are disposed along a lower side 2A, and the connecting terminal groups 32B are disposed along an upper side 2B. The connecting terminal groups 32A and 32B provided at the top and bottom sides are connected respectively to address electrodes 15A and 15B within a common address electrode group 15G. Specifically, a plurality of address electrodes 15 are alternately connected to the connecting terminal groups 32A of the lower side 2A and the connecting terminal group 32B of the upper side 2B.

In FIG. 3, the pitch of the address electrodes P1 becomes narrower than the pitch of the connecting terminals P2 as the number of address electrodes increases. For this reason, all connecting terminal groups 32 cannot be provided along the lower side 2A. Therefore, the connecting terminal groups 32 are separated to be disposed on the lower side 2A and upper side 2B, and the address electrodes 15A and 15B are alternately connected to the lower connecting terminal groups 32A and the upper connecting terminal groups 32B. Accordingly, the address electrode group 15G has the address electrodes 15A and 15B, the number of which is twice as many as the number of terminals of the connecting terminal group 32A, and the horizontal width W11 of the address electrode group 15G becomes extremely wider than the horizontal width W2 of the connecting terminal group 32A.

Due to such relationship between the horizontal widths where W11>W2 is established, the pitch of the leading lines 34 connecting the address electrodes 15A to the connecting terminals 32A becomes narrow, causing a short circuit failure. Particularly, in the case in which the pitch of the address electrodes P1 is slightly narrower than the pitch of the connecting terminals P2, the W11 becomes approximately twice as large as W2, and the spread angle between the leading lines 34 increases, whereby a short circuit failure occurs easily.

Moreover, in the example shown in FIG. 3, since a pair of connecting terminal groups 32A and 32B are disposed so as to face each other, the number of connecting terminal groups 32A on the lower side 2A becomes equal to the number of connecting terminal groups 32B on the upper side 2B. On the other hand, a currently popular standard drive circuit device can drive 384 (128×3) address electrodes. Therefore, in order to drive 5760 (1920×3) address electrodes of the full-spec hi-vision television, eight drive units need to be provided on the top and bottom of the panel and connected to the connecting terminal groups 32A and 32B. Specifically, a total of sixteen drive units are provided, and the number of electrodes that can be driven is 384×16=6144, which is larger than 5760. Therefore, some drive units cannot use the full power of the drive circuit device; which is an obstruction to the cost reduction.

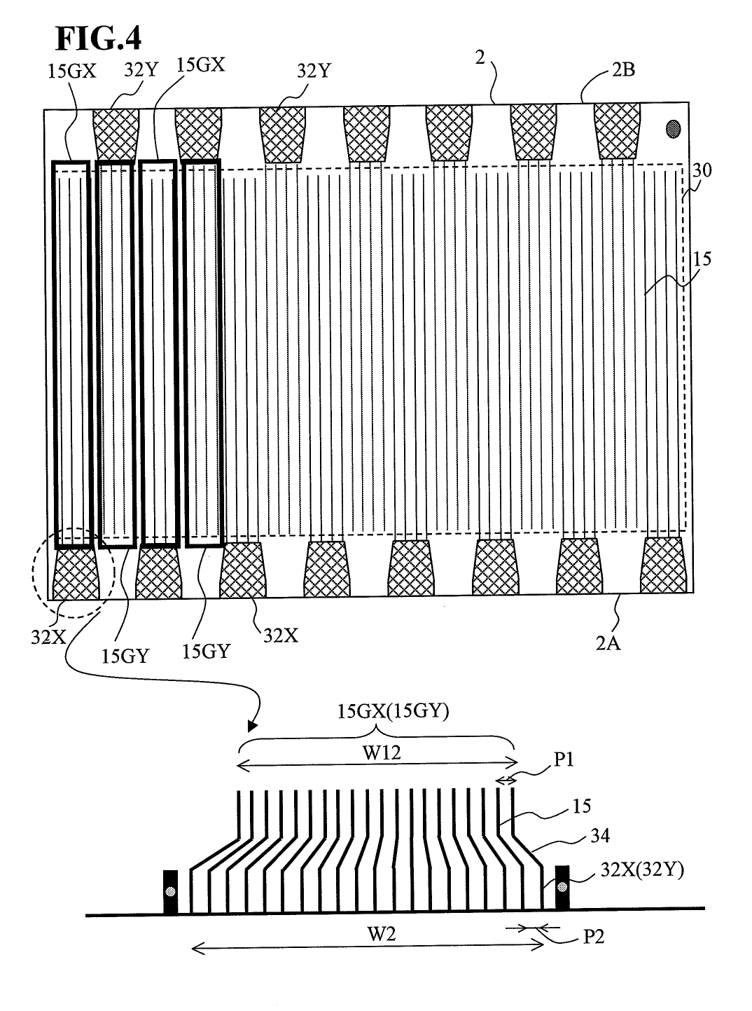

FIG. 4 is a configuration diagram of the display panel according to the present embodiment. As with FIG. 2 and FIG. 3, FIG. 4 shows a plan view of the rear glass substrate 2. A plurality of address electrodes 15 are formed in the effective display area 30 within the rear glass substrate 2. As shown by the thick frames, the plurality of address electrodes 15 are broken up into a plurality of groups (fifteen groups in the example of FIG. 4) of address electrode groups 15GX and 15GY, each of which is composed of a predetermined number of successive adjacent address electrodes 15. An odd-numbered first address electrode group 15GX, counted from the left side of the panel 2, is connected to a connecting terminal group 32X disposed on the lower side 2A of the panel, and an even-numbered second address electrode group 15GY is connected to a connecting terminal group 32Y disposed on the upper side 2B of the panel. Specifically, the first and second address electrode groups are disposed alternately and connected to the top and bottom connecting terminal groups.

The number of terminals in each of the connecting terminal groups 32X and 32Y is the same as the number of address electrodes in each of the address electrode groups 15GX and 15GY. Of the fifteen address electrode groups 15GX, 15GY, eight first address electrode groups 15GX are connected respectively to eight connecting terminal groups 32X disposed on the lower side, and seven (=15-8) second address electrode groups 15GY are connected respectively to seven connecting terminal groups 32Y disposed on the upper side. Specifically, the total number of the connecting terminal groups 32X and 32Y is fifteen.

FIG. 4 shows an enlarged connecting terminal group 32X. As with the example shown in FIG. 3, the pitch of the address electrodes 15, P1, is narrower than the pitch of the connecting terminals P2. Since the address electrode group 15GX is composed of a predetermined number of successive adjacent address electrodes 15, the horizontal width W12 of the address electrode group is narrower than the horizontal width W2 of the connecting terminal group 32X. Therefore, the leading lines 34 connecting the both groups have a pattern of spreading out from the address electrodes toward the connecting terminal group.

Particularly, in the case in which the pitch of the address electrodes P1 is slightly narrower than the pitch of the connecting terminals P2, the difference between the horizontal width W12 and W2 is not as large as the difference between the horizontal width W11 and W2 shown in FIG. 3, and the spread angle between the leading lines 34 is smaller than that shown in FIG. 3. Therefore, the density of the leading lines 34 is not too high, thus the possibility of a short circuit failure is inhibited. This becomes clear by comparing the leading lines 34 between FIG. 3 and FIG. 4.

It should be noted that the pitch of the address electrodes P1 is approximately 0.16 mm in the case in which the panel is a 42-inch full-spec high-resolution panel, approximately 0.19 mm in the case of 50 inches, approximately 0.23 mm in the case of 60 inches, and approximately 0.25 mm in the case of 65 inches. The pitch of the connecting terminal P2 is 0.2 to 0.3 mm.

As described above, when the pitch of the address electrodes P1 is narrower than the pitch of the connecting terminals P2, the connecting terminal groups 32X, Y need to be separated into the top and bottom sides; however, in the present embodiment, the first and second connecting terminal groups 32X and 32Y at the top and bottom are connected respectively to the address electrode groups 15GX and 15GY, each of which is composed of a predetermined number of successive adjacent address electrodes, whereby the density of the leading lines can be reduced.

Furthermore, in the case of a high-resolution panel for a full-spec hi-vision television, the number of address electrodes 15 is 5760 (=1920×3). Also, if the number of terminals in each of the connecting terminal groups 32X and 32Y conforms to the number of terminals of the standard drive circuit device, that is, 384 (=128×3), then the number of connecting terminal groups becomes fifteen and the number of address electrode groups also becomes fifteen, thus the drive circuit device can be used economically. Moreover, when comparing the sixteen connecting terminal groups shown in FIG. 3 with sixteen drive units that are connected thereto respectively, only fifteen drive units are required, thus the number of drive units can be reduced by one, which leads to cost reduction, electric power saving, and heat value saving.

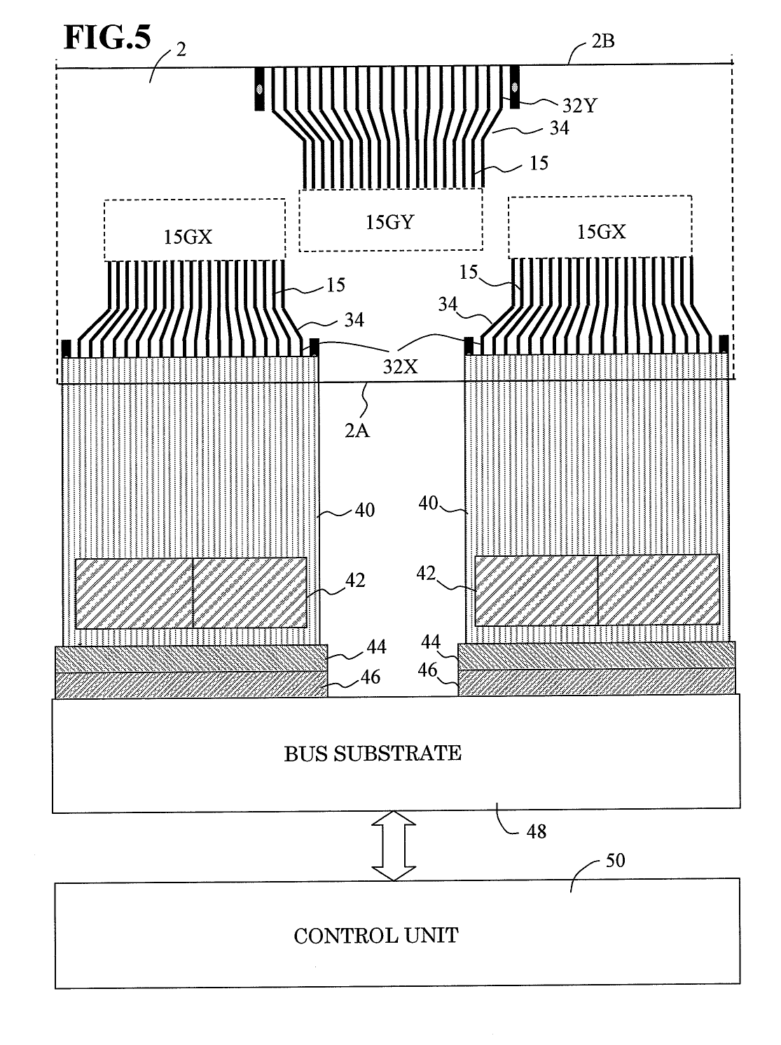

FIG. 5 is a configuration diagram of a display panel module according to the present embodiment. A drive unit, which is constituted by flexible printed circuit boards 40 having conductive wires formed therein and drive circuit devices 42 mounted on the flexible printed circuit boards 40, is connected to the display panel 2 shown in FIG. 4, by the connecting terminal groups 32X. FIG. 5 shows the drive unit placed on the lower side 2A only. The drive unit on the upper side 2B is omitted due to limitations of space, but the drive unit is actually connected to the connecting terminal groups 32Y.

Each of the flexible printed circuit board 40 has the conductive wires, the number of which is the same as that of the connecting terminal groups 32X (384 wires, in the above example), and each of the drive circuit devices 42 similarly has 384 drive terminals. The drive circuit device 42 within one drive unit drives the 384 address electrodes within the address electrode group 15GX via the conductive wires of the flexible printed circuit board 40.

A connector 44 is provided on the opposite side of each of the flexible printed circuit board 40, and is connected to a connector 46 of a bus substrate 48. The bus substrate 48 has a bus wire for supplying drive data, drive timing signals, power source and the like to the drive circuit devices 42. The bus substrate 48 is connected to a control unit 50 on which a CPU, frame memory, power source unit and the like are mounted. The drive circuit device 42, the bus substrate 48, and the control unit 50 can be disposed on the back of the display panel by bending the flexible printed circuit board 40.

In the examples shown in FIG. 4 and FIG. 5, the address electrode groups 15X and 15Y are connected to the top and bottom connecting terminal groups 32X and 32Y alternately. In the case of the display panel for a hi-vision television, these connecting terminal groups are divided into fifteen groups: eight connecting terminal groups 32X are provided along the lower side 2A of the panel; and seven connecting terminal groups 32Y are provided along the upper side 2B of the panel. In the present embodiment, the address electrode groups are not necessarily connected alternately to the connecting terminal groups. The connecting terminal groups may be allocated to every two groups at the top and bottom to connect two address electrode groups 15GX to the connecting terminal 32X on the lower side, and to connect the subsequent one address electrode group 15GY to the connecting terminal groups 32Y on the upper side. The number of connecting terminal groups at the top may not necessarily be the same as or different by one from the one on the bottom.

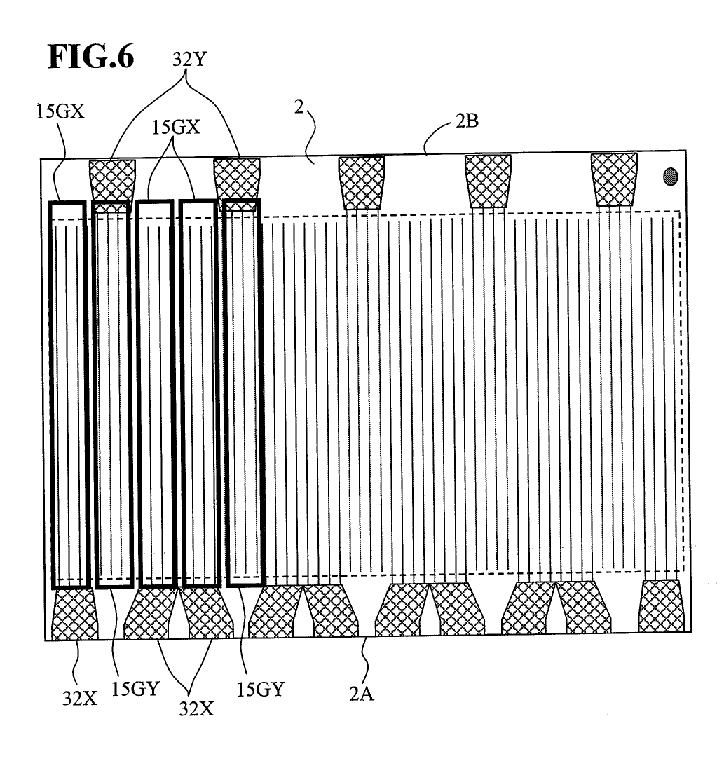

FIG. 6 is a configuration diagram of another display panel according to the present embodiment. As shown on the left side of the panel 2 in this example, one first address electrode group 15GX is connected to a connecting terminal group 32X on the lower side 2A, the next one second address electrode group 15GY is connected to a connecting terminal group 32Y on the upper side 2B, the subsequent two first address electrode groups 15GX are connected to two connecting terminal groups 32X on the lower side 2A respectively, and the following one second address electrode group 15GY is connected to a connecting terminal group 32Y on the upper side 2B. As with this manner, subsequently, two first address electrode groups and one second address electrode group are connected alternately to top and bottom connecting terminal groups 32X and 32Y. Therefore, ten connecting terminal groups 32X are formed on the lower side 2A of the panel, while five connecting terminal groups 32Y are formed on the upper side 2B, and each of these connecting terminal groups is connected to the drive unit that is not shown.

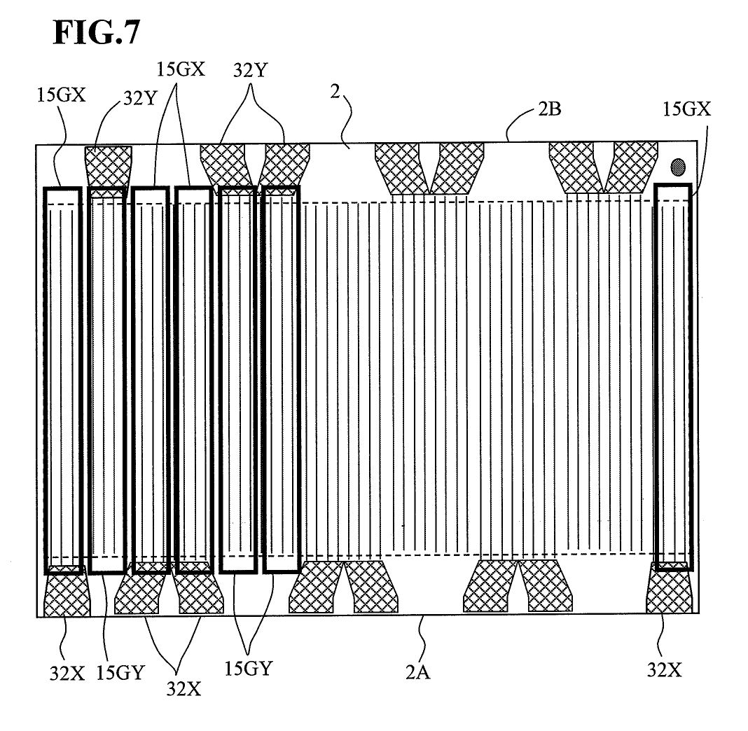

FIG. 7 is a configuration diagram of yet another display panel according to the present embodiment. As shown on the left side of the panel 2 in this example, one first address electrode group 15GX is connected to a connecting terminal group 32X on the lower side 2A, the next one second address electrode group 15GY is connected to a connecting terminal group 32Y on the upper side 2B, the subsequent two first address electrode groups 15GX are connected to two connecting terminal groups 32X on the lower side 2A respectively, and the following two second address electrode groups 15GY are connected to connecting terminal groups 32Y on the upper side 2B. As with this manner, subsequently, every pair of first and second address electrode groups 15GX and 15GY are connected to the connecting terminal groups 32X and 32Y at the top and bottom. Then, one first address electrode group 15GX on the rightmost end is connected to a connecting terminal group 32X on the lower side 2A. Therefore, eight connecting terminal groups 32X are formed on the lower side 2A of the panel, while seven connecting terminal groups 32Y are formed on the upper side 2B, and each of these connecting terminal groups is connected to the drive unit that is not shown.

The above has described examples of the address electrodes extending in the vertical direction of the display panel, the connecting terminal groups of the address electrodes, and the drive units. However, the present embodiment can be applied similarly to the display electrodes extending in the horizontal direction of the display panel, the connecting terminal groups of the display electrodes, and the drive units. Moreover, the above has described examples of a plasma display panel, but the present embodiment can be similarly applied to the electrodes of a liquid crystal display panel or an organic EL display panel.

What is claimed is:

1. A display panel having a plurality of electrode wires that are formed in a display area and connected to a plurality of drive units,
wherein the plurality of electrode wires form N number of electrode wire groups, each of which is composed of M number of successive adjacent electrode wires,
the display panel comprising
a plurality of first connecting terminal groups, which are arranged along a first side of the display panel and each of which has M terminals; and
a plurality of second connecting terminal groups, which are arranged along a second side of the display panel opposite to the first side and each of which has M terminals,
K number of electrode wire groups out of the N number of electrode wire groups (K<N) are connected via leading lines to the first connecting terminal groups respectively,
N−K number of electrode wire groups out of the N number of electrode wire groups are connected via leading lines to the second connecting terminal groups respectively, and
the K number of electrode wire groups and the N−K number of electrode wire groups are arranged alternately or in alternate sets of a plurality of groups.

2. The display panel according to claim 1, wherein the number of M electrode wires is 384, the number of M terminals is 384, the number of N groups is 15, and the electrode wires are composed of 5760 electrodes.

3. The display panel according to claim 2, wherein
the number of K groups is seven, the number of N−K groups is eight,
seven groups of the first connecting terminal groups are connected to seven drive units respectively along the first side, and
eight groups of the second connecting terminal groups are connected to eight drive units respectively along the second side.

4. A display panel module having a display panel in which a plurality of electrode wires are formed in a display area thereof, and a plurality of drive units to which the electrode wires are connected respectively,
wherein the plurality of electrode wires form N number of electrode wires, each of which is composed of M number of successive adjacent electrode wires,
the display panel comprising
a plurality of first connecting terminal groups, which are arranged along a first side of the display panel and each of which has M terminals; and
a plurality of second connecting terminal groups, which are arranged along a second side of the display panel opposite to the first side and each of which has M terminals,
K number of electrode wire groups out of the N number of electrode wire groups (K<N) are connected via leading lines to the first connecting terminal groups respectively,
N−K number of electrode wire groups out of the N number of electrode wire groups are connected via leading lines to the second connecting terminal groups respectively,
the K number of electrode wire groups and the N−K number of electrode wire groups are arranged alternately or in alternate sets of a plurality of groups, and
the plurality of drive units are connected to the first and second connecting terminal groups respectively.

5. The display panel module according to claim 4, wherein the number of M electrode wires is 384, the number of M terminals is 384, the number of N groups is 15, the electrode wires are composed of 5760 electrodes, and the plurality of drive units are composed of fifteen units.
